(19) United States
(12) Patent Application Publication
(10) Pub. No.: US 2026/0003759 A1
(43) Pub. Date: Jan. 1, 2026

(54) SYSTEMS AND METHODS FOR CONNECTED DEVICE AND APPLICATION PERFORMANCE MANAGEMENT

(71) Applicant: PLUME DESIGN, INC., Palo Alto, CA (US)

(72) Inventors: Richard Tzewei CHANG, Los Altos Hills, CA (US); Yusuke SAKAMOTO, Campbell, CA (US); Sameer Krishnaji VAIDYA, Saratoga, CA (US)

(21) Appl. No.: 18/760,380

(22) Filed: Jul. 1, 2024

(51) Int. Cl. G06F 11/34

(52) U.S. Cl. CPC G06F 11/3409

(57) ABSTRACT

The disclosed computer-implemented method may include receiving telemetry data from a devices corresponding to a computing item and predicting performance factors for the computing item using the received telemetry data. The method may also include generate a weighting scheme and applying the weighting scheme to the performance factors to determine a performance metric for the computing item. Various other methods, systems, and computer-readable media are also disclosed.

### SUMMARY OF THE DISCLOSURE

The traditional 25-year-old eCommerce and App Store rating systems that are dominated by crowd-sourced product reviews and ratings that are voluntary, subject to fraud and manipulation by the manufacturer and review bombing by nefarious netizens, and generally reflect only initial, subjective impressions. As discussed herein, the disclosed systems and methods operate to leverage vast amounts of Cloud data and capabilities associated with provided data networks to create comprehensive, multi-faceted “experience scores” for a diverse range of client devices and applications, which are not only more reliable because they remove human bias and continually monitor the product usage over its entire lifetime using proprietary telemetry, but also improve operation of such connected devices/applications based therefrom. The disclosed systems and methods can leverage data from billions of connected devices (e.g., via Cloud-based Wi-Fi data for specific users, customers and/or geographic regions, for example), which can be scaled to ensure the integrity and accuracy of such scores and subsequently based computer/application operations.

According to some embodiments, an experience Score can provide capabilities to build awareness in the consumer space and incentivize Internet Service Providers (ISPs) and content service providers (CSPs) to utilize curate application services to collect related data, and utilize such data to compile the scores and operations therefrom.

According to some embodiments, the disclosed systems and methods can operate to construct a data structure (e.g., data file, and/or executable file) for the experience score via an algorithmic set of operations for client devices and apps based on historical data on our network, which encompasses popularity, longevity, connectivity reliability, and security. In some embodiments, a score can be calculated from data passively collected from all locations/devices/apps and reflects the entire product experience, including predetermined amount of time (e.g., 30-day) survival rate, daily usage over time, average lifespan on the network, and/or any security or connectivity issues. As discussed herein, known or to be known Artificial Intelligence and/or Machine learning (AI/ML) algorithms, and/or large language models (LLMs) can be utilized to perform data cleaning, remove temporary, guest devices, and outliers, and automatically rank devices/apps within the same device/app category. Accordingly, as discussed herein, any determined issues in data can also be used to improve the underlying device typing, guard, and complementary services. In some embodiments, such scoring determination can be calculated in an offline fashion on a regular interval (e.g., weekly/monthly) to provide trends over time, which can be stored in a database (and utilized for later score determinations and/or updates).

According to some embodiments, such scores can be published on different channels, platforms and/or applications, and/or to differing types of parties, which can include, users, ISPs, CSPs, eCommerce retailers, and the like. For example, within a dedicated experience score website, interacting users can compare different devices/apps based on device/app categories and scores. For example, scores will be available for device categories like cameras, game consoles, phones, and smart TVs. In some embodiments, permissioned-based access and/or an unabridged index of all devices may live behind a paywall for subscribers and/or ISP/CSP partner subscribers.

In some embodiments, within an application of a provider, an interactive listing for all device categories can be provided, which can enable filtering based on any of the attributes of the experience score and geographical location (e.g., highest scores for security in Europe, for example). In some embodiments, such scores can be provided for devices within particular locations and/or AI/ML-generated assessments. For example, “Your devices average an A-rating.” In another non-limiting example, “Your Apple HomePod is rated the best in its category, and your Wyze camera has flagged more suspicious activity than the average.” Thus, the disclosed systems and methods are configured to offer and/or provide capabilities that offer a determined context to security notifications.

In some embodiments, the disclosed systems and methods can operate to flag (e.g., tag, annotate, or otherwise identify) problematic devices/applications so that a support team can quickly triage any issues. For example, an experience score can suggest if this particular device model is more problematic than its peer group.

In some embodiments, for example, experience scores can be provided to ISPs and/or CSPs, which can be utilized to improve their customer support and experience. For example, experience scores can be bundled with other applications and/or functionalities to provide individualized experiences, as discussed herein.

Accordingly, as discussed herein, the disclosed systems and methods provide computerized data pipelines and AI/ML algorithms that can execute to calculate such experience scores from a set of underlying available data, which can be automatically and/or dynamically updated to ensure up-to-date feedback for users. As provided below, some different device categories may require different weightings of these factors to reflect the importance of each in the end product. For example, consistency of connection for security cameras may be more important than that of gaming devices. Thus, the disclosed systems and methods can use AI/ML algorithms to achieve a desired weighting of each factor in the final scores. Moreover, in some embodiments, such AI/ML models can be curated to predict/augment a potential sparsity of the dataset. For example, the average lifetime of connected refrigerators may exceed an existing dataset age. Thus, the disclosed systems and methods can determine the expected lifetime using the customized/curated AI/ML algorithms.

According to some embodiments, a method is disclosed for data augmented performance metrics, and mechanisms for utilizing such mechanisms to control how devices/applications operate, inclusive of the devices they interact with, content sources they engage and/or applications that are run on such devices. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for data augmented performance metrics, and mechanisms for utilizing such mechanisms to control how devices/applications operate.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for data augmented performance metrics according to some embodiments of the present disclosure;

FIG. 2 is a block diagram of an exemplary system for data augmented performance metrics according to some embodiments of the present disclosure;

FIG. 3 is a block diagram of an exemplary network for data augmented performance metrics according to some embodiments of the present disclosure;

FIG. 4 is a diagram of an exemplary environment of computing devices for data augmented performance metrics according to some embodiments of the present disclosure;

FIG. 5 is a diagram of an exemplary data flow for data augmented performance metrics according to some embodiments of the present disclosure; and

FIG. 6 is a diagram of an exemplary weighting scheme for data augmented performance metrics according to some embodiments of the present disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Performance and quality of computing items (e.g., hardware and/or software) are often measured through various types of metrics. For example, during design stages, manufacturers may use various benchmarks to assess whether the device meets certain performance thresholds or milestones. App testing may also undergo benchmarking. However, such testing data simulates device/app usage over a simulated lifetime rather than actual usage data (e.g., usage by end users).

Further, this testing data is often not publicly available to consumers or users. Consumers or users may therefore rely on various other available metrics when deciding to purchase a device and/or app. For example, users of devices may rely on crowd-sourced product reviews and ratings. However, such ratings may be subject to fraud and/or manipulation (e.g., by manufacturers, review bombing by certain users), other biases, and further are often limited to initial, subjective impressions.

Actual usage data may provide a more accurate performance metric. However, actual usage data may be difficult to collect and process and at times may be incomplete for certain performance metrics.

The present disclosure is generally directed to data augmented performance metrics, and mechanisms for utilizing such mechanisms to control how devices operate, inclusive of the devices they interact with, content sources they engage and/or applications that are run on such devices. As will be explained in greater detail below, embodiments of the present disclosure may receive telemetry data for a computing item (e.g., a computing device/hardware item and/or computing software item) and use the telemetry data for predicting various relevant performance factors for the computing item. By combining the performance factors using a weighting scheme, the systems and methods described herein may determine a performance metric for the computing item, which can be leveraged to execute and/or operate the computing item (e.g., which can improve how the computing item performs, as it relates to, but not limited to, accuracy, efficiency and resource usage (e.g., less drain on processor, memory and network resources to perform the operation of the computing item based on the performance metric).

Accordingly, among other benefits the disclosed systems and methods provided herein can advantageously generate an accurate performance metric by more efficiently collecting telemetry data (e.g., during normal usage of the computing item) to reduce network bandwidth for doing so, and further improve performance metric prediction and utilization by augmenting data for sparse data sets for use by a machine learning model. Moreover, the systems and methods described herein may improve the field of machine learning (ML) by leveraging multiple machine learning models to improve data used as inputs into ML models, as well as efficiently utilize different ML models for a resulting prediction/classification.

Features from any of the embodiments described herein may be used in combination with one another in accordance with the general principles described herein. These and other embodiments, features, and advantages will be more fully understood upon reading the following detailed description in conjunction with the accompanying drawings and claims.

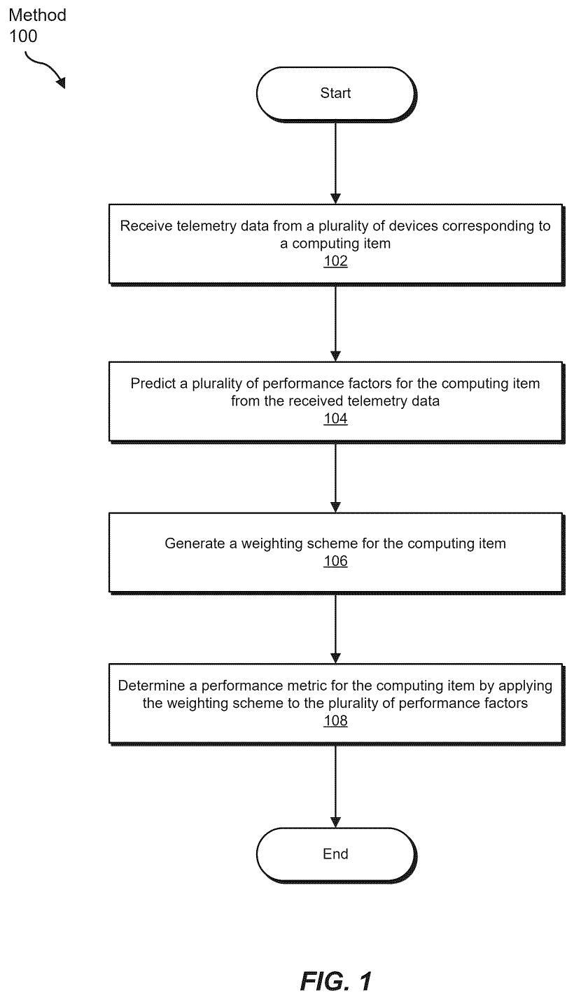

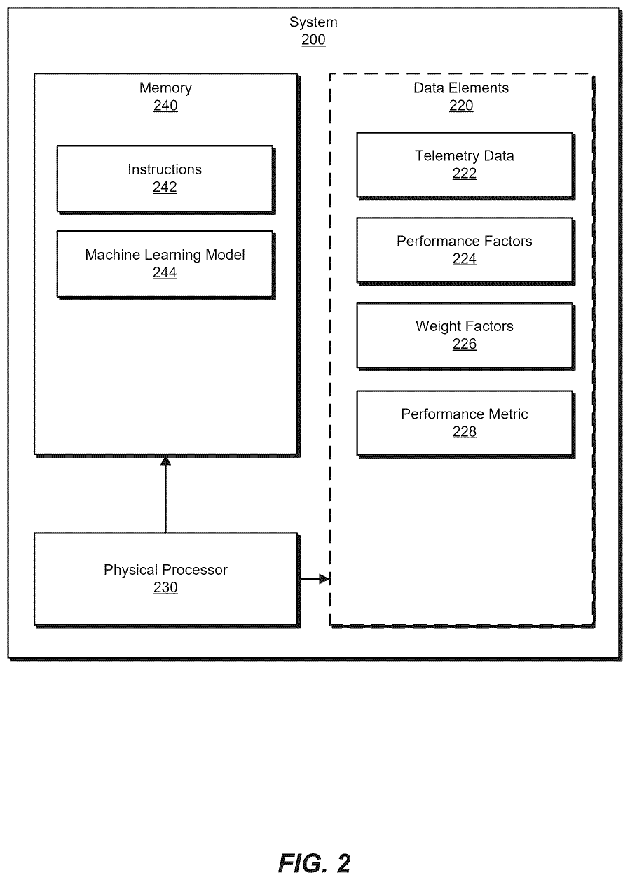

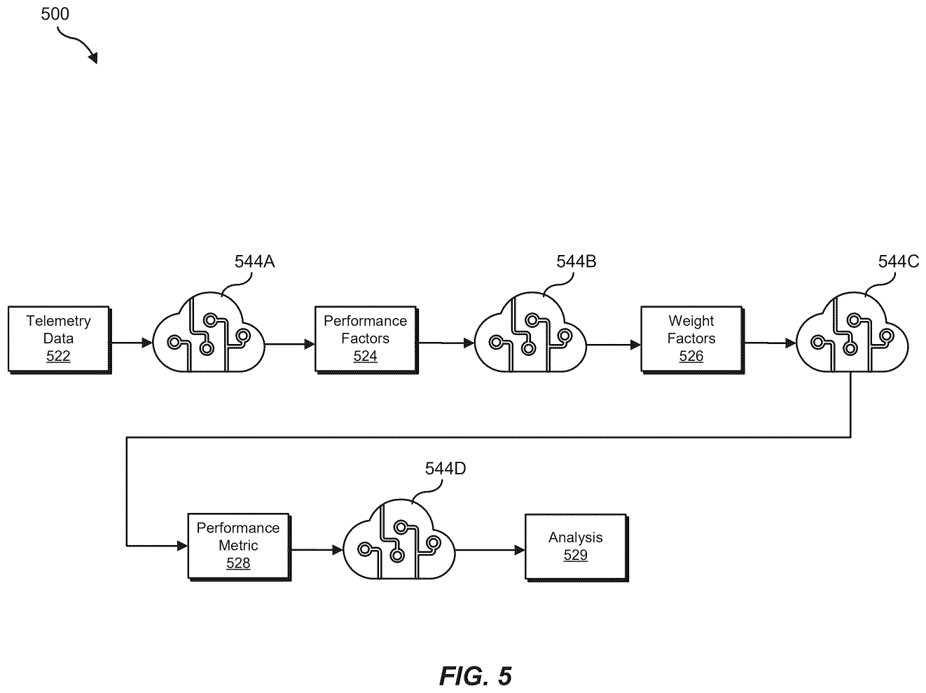

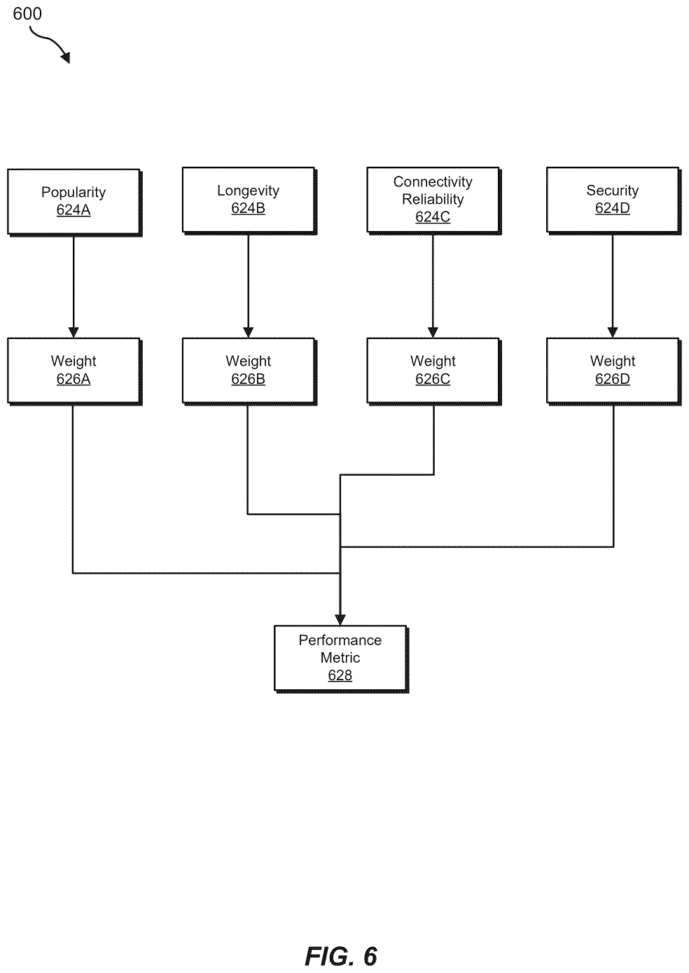

The following will provide, with reference to FIGS. 1-6, detailed descriptions of systems and methods for data augmented performance metrics. Detailed descriptions of an example method for generating data augmented performance metrics will be provided in connection with FIG. 1. Detailed descriptions of example systems and devices for data augmented performance metrics will be provided in connection with FIGS. 2, 3, and 4. Detailed descriptions of example ML models for data augmented performance metrics will also be provided in connection with FIGS. 5 and 6.

FIG. 1 is a flow diagram of an exemplary computer-implemented method 100 for generating data augmented performance metrics. The steps shown in FIG. 1 may be performed by any suitable computer-executable code and/or computing system, including the system(s) illustrated in FIGS. 2 and/or 3. In one example, each of the steps shown in FIG. 1 may represent an algorithm whose structure includes and/or is represented by multiple sub-steps, examples of which will be provided in greater detail below.

As illustrated in FIG. 1, at step 102 one or more of the systems described herein may receive telemetry data from a plurality of devices corresponding to a computing item. For example, a machine learning model 244 in FIG. 2 may receive telemetry data 222 corresponding to a computing item.

In some embodiments, a computing item may correspond to computer hardware and/or software, often as an overall item rather than components (e.g., a product such as an electronic device or an application/app). Examples of computing items include, without limitation, mobile devices, smartphones, computers, laptops, smart watches, smart devices, Internet-of-Things (IoT) devices, cameras (e.g., security cameras), game consoles, smart televisions, software applications, apps, games, other consumer products, etc.

Various systems described herein may perform step 102. FIG. 2 is a block diagram of an example system 200 for data augmented performance metrics. As illustrated in this figure, example system 200 may include one or more instructions 242 (e.g., computer executable instructions) for performing one or more tasks as described herein. As will be explained in greater detail herein, memory 240 further includes machine learning model 244, that may represent hardware and software for artificial intelligence, and may correspond to one or more machine learning models (e.g., supervised machine learning models, unsupervised machine learning models, semi-supervised machine learning models, reinforcement learning models, etc.) including but not limited to artificial neural networks, convolutional neural networks, generative models, language models, etc. Although illustrated as separate elements, one or more of instructions 242 and machine learning model 244 in FIG. 2 may represent portions of a single module or application.

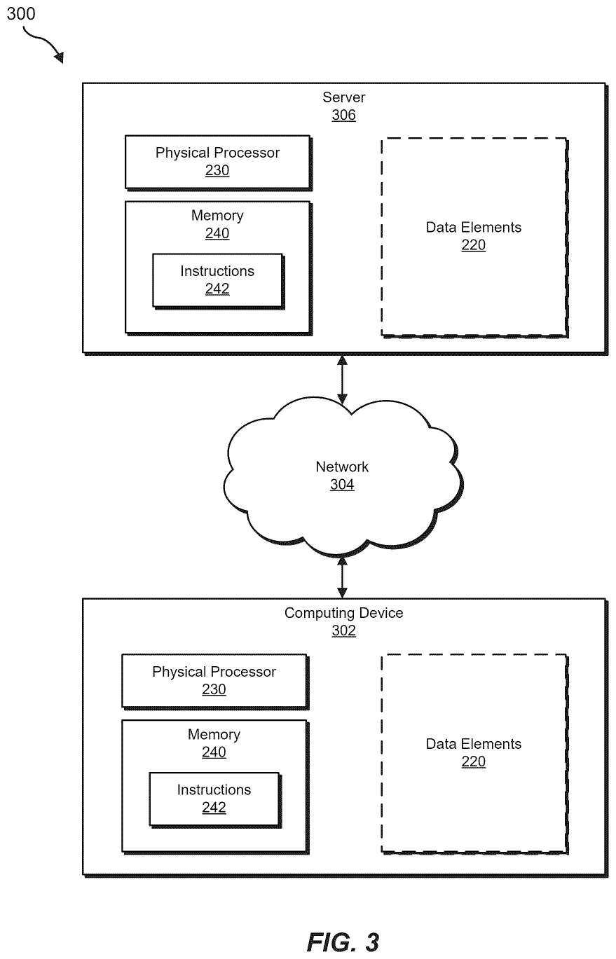

In certain embodiments, one or more of instructions 242 in FIG. 2 may represent one or more software applications or programs that, when executed by a computing device, may cause the computing device to perform one or more tasks. For example, and as will be described in greater detail below, one or more of instructions 242 may represent modules stored and configured to run on one or more computing devices, such as the devices illustrated in FIG. 3 (e.g., computing device 302 and/or server 306). One or more of instructions 242 in FIG. 2 may also represent all or portions of one or more special-purpose computers configured to perform one or more tasks.

As illustrated in FIG. 2, example system 200 may also include one or more memory devices, such as memory 240. Memory 240 generally represents any type or form of volatile or non-volatile storage device or medium capable of storing data and/or computer-readable instructions. In one example, memory 240 may store, load, and/or maintain one or more of instructions 242. Examples of memory 240 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 2, example system 200 may also include one or more physical processors, such as physical processor 230. Physical processor 230 generally represents any type or form of hardware-implemented processing unit capable of interpreting and/or executing computer-readable instructions. In one example, physical processor 230 may access and/or modify one or more of instructions 242 stored in memory 240. Additionally or alternatively, physical processor 230 may execute one or more of instructions 242 to generate data augmented performance metrics as described herein. Examples of physical processor 230 include, without limitation, microprocessors, microcontrollers, Central Processing Units (CPUs), Field-Programmable Gate Arrays (FPGAs) that implement softcore processors, Application-Specific Integrated Circuits (ASICs), graphics processing units (GPUs), hardware accelerators, co-processors, portions of one or more of the same, variations or combinations of one or more of the same, and/or any other suitable physical processor.

As illustrated in FIG. 2, example system 200 may also include one or more data elements 220, such as telemetry data 222, performance factors 224, weight factors 226, and a performance metric 228. Telemetry data 222, performance factors 224, weight factors 226, and/or performance metric 228 may be stored on a local storage device, such as memory 240, or may be accessed remotely. Telemetry data 222 may represent telemetry data (e.g., data from actual usage) for a computing item, as will be explained further below. Performance factors 224 may represent predictive scores measuring various aspects relating to the computing item. Weight factors 226 may represent a weighting scheme for combining the values of performance factors 224. Performance metric 228 may represent an overall performance metric (e.g., a weighted combination of performance factors 224), as will be explained further below.

Example system 200 in FIG. 2 may be implemented in a variety of ways. For example, all or a portion of example system 200 may represent portions of example network environment 300 in FIG. 3.

FIG. 3 illustrates an exemplary network environment 300 implementing aspects of the present disclosure. The network environment 300 includes computing device 302, a network 304, and server 306. Computing device 302 may be a client device or user device, such as a desktop computer, laptop computer, tablet device, smartphone, or other computing device including an appliance or other device having an integrated computer. Computing device 302 may include a physical processor 230, which may be one or more processors, memory 240, which may store data such as one or more of data elements 220.

Server 306 may represent or include one or more servers capable of receiving telemetry data (e.g., telemetry data 222) and generating a data augmented performance metric (e.g., performance metric 228). Server 306 may use one or more machine learning models (e.g., one or more iterations of machine learning model 244) to augment data for generating the performance metric. Server 306 may include a physical processor 230, which may include one or more processors, memory 240, which may store instructions 242, and one or more of data elements 220.

Computing device 302 may be communicatively coupled to server 306 through network 304. Network 304 may represent any type or form of communication network, such as the Internet, and may comprise one or more physical connections, such as LAN, and/or wireless connections, such as WAN.

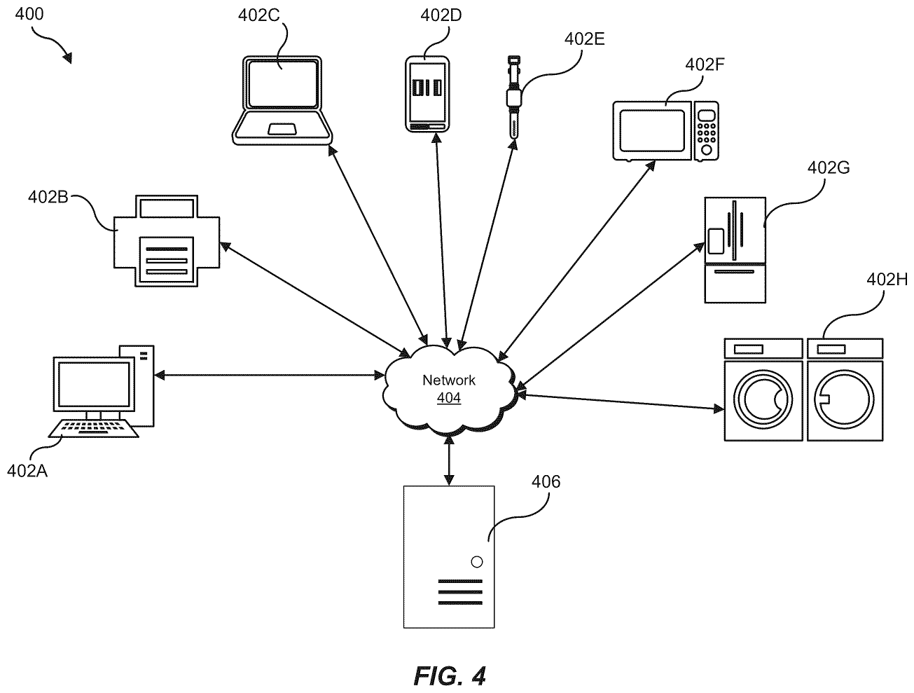

As described herein, the computing item may correspond to a computer hardware item and/or a computer software item. FIG. 4 illustrates a network environment 400 (corresponding to network environment 300) of various examples of computing items 402A-402H (each corresponding to an iteration of computing device 302). For instance computing item 402A may correspond to a desktop computer, computing item 402B may correspond to a printer, computing item 402C may correspond to a laptop, computing item 402D may correspond to a smartphone, computing item 402E may correspond to a smartwatch (or other wearable device), computing item 402F may correspond to a smart microwave oven, computing item 402G may correspond to a smart refrigerator, and computing item 402H may correspond to a smart washer and dryer (or other smart appliance). Further, although not explicitly shown in FIG. 4, additional examples of computing items may include software running on any of the devices shown, such as an app or other software product. Moreover, FIG. 4 illustrates a non-exhaustive list of example computing items.

FIG. 4 also includes a network 404 (corresponding to network 304). The computing items (e.g., computing items 402A-402H and/or software) connect to a server 406 (corresponding to server 306) via network 404. The computing items may directly and/or indirectly communicate with server 406 for various reasons during normal operation, such as for network communication/configuration (e.g., adaptive WiFi services including monitoring and/or optimizing), cloud computing services, security/privacy services, etc. In other words, server 406 may be part of a network providing services to the computing items. Server 406 may passively collect telemetry data during normal operations in order to provide end users with desired services. The telemetry data may therefore include historical data of actual usage as collected from across various geographical locations, and may reflect a product experience, such as a survival rate (e.g., a 30-day survival rate for whether usage continues after 30 days), average lifespan on the network, security issues (e.g., blocked events, anomaly events, etc.), connectivity issues (connection reliability events, app outage incidents, etc.), other device usage data, other network connectivity data, other device security data, etc., as well as other related data such as Quality-of-Experience (QoE) that may be available. The telemetry data may be anonymized and aggregated to protect privacy and further comply with all privacy regulations.

FIG. 4 illustrates multiple types of computing items. However, the examples described further below may refer to telemetry data for a specific computing item (e.g., telemetry data from multiple iterations of the computing item such as telemetry data collected for multiple instances of a specific smartphone model, specific app, etc.) and/or category, such that predictive analysis may be performed for the particular computing item/category. In some examples, a machine learning model (e.g., machine learning model 244) may also classify a computing item (e.g., identify the particular model) and/or category/type from the telemetry data.

Returning to FIG. 1, at step 104 one or more of the systems described herein may predict a plurality of performance factors for the computing item from the received telemetry data. For example, machine learning model 244 may predict performance factors 224 for the computing item using telemetry data 222.

The systems described herein may perform step 104 in a variety of ways. In one example, different ML models may be used for different predictions, such as a machine learning model trained to predict performance factors for the computing item. FIG. 5 illustrates an example data flow 500 and includes telemetry data 522 (corresponding to telemetry data 222), an ML model 544A (corresponding to an instance of machine learning model 244), performance factors 524 (corresponding to performance factors 224), an ML model 544B (corresponding to an instance of machine learning model 244), weight factors 526 (corresponding to weight factors 226), an ML model 544C (corresponding to an instance of machine learning model 244), a performance metric 528 (corresponding to performance metric 228), an ML model 544D (corresponding to an instance of machine learning model 244), and analysis 529, which will be described further below.

ML model 544A may represent one or more ML models for predicting performance factors 524. In some implementations, ML model 544A may clean, augment, and/or otherwise improve a quality of telemetry data 522. For example, ML model 544A may detect a sparsity of telemetry data 522. The sparsity may be due to a lack of available data (e.g., a new device such that the amount of data may not be statistically significant, data for device usage lifetimes for devices such as appliance having a long lifetime, application usage data, etc.), the quality of available data is low (e.g., resulting in data cleaning described further below), etc. Based on the sparsity, ML model 544A may augment telemetry data 522. Augmenting the data may include, for instance, inferring and/or predicting data (e.g., using data from similar computing items and/or category) such as lifetime usage data, app time data, etc. Such augmentation may be used to supplement the data until the lacking data is available (e.g., which can enable the system to operate until such data is available). In some examples, certain types of data (e.g., QoE) may not be augmented.

ML model 544A may further clean telemetry data 522. ML model 544A may detect outlier data and/or other noisy data and remove the detected outlier data. For example, outlier data may correspond to data relating to temporary device usage, guest device usage, poor network usage (e.g., identifying a poorly performing network that may be degrading network performance of the computing item), etc.

Using the augmented and/or cleaned telemetry data 522, ML model 544A may accordingly predict performance factors 524 (e.g., predict values for various relevant quantitative attributes relating to performance). ML model 544A may be trained to predict, for the computing item and/or corresponding category, values for performance factors 524. FIG. 6 illustrates examples of performance factors.

FIG. 6 illustrates a weighting scheme 600 for a popularity factor 624A, a longevity factor 624B, a connectivity reliability factor 624C, and a security factor 624D (each corresponding to instances of performance factors 224), although in other implementations other factors and/or combinations thereof may be used. Popularity factor 624A may correspond to a score represented by per capita counts of the computing item seen active (e.g., as observed by and/or connected to server 406) or apps being consumed (e.g., purchased/used, etc.). Longevity factor 624B may correspond to score represented by a usage churn rate of the computing item, such as a 30-day churn rate, 90-day churn rate, 365-day churn rate, daily usage over time, average lifespan (e.g., as observed by and/or connected to server 406).

Connectivity reliability factor 624C may correspond to a score represented by network-related degradation events relating to the computing item, such as connectivity and service availability issues. For hardware computing items (e.g., a device model), reliability may be measured as the average QoE scores and number of disconnects compared to the peer device models. As described above, the scoring may only include networks with good or excellent health ratings, and discount any networks with more than a threshold (e.g., 3) number of poor QOE clients to distinguish between network and individual device performance. For software computing items (e.g., apps), reliability may be measured as the average QoE scores, frequency of app outage incidents, and frequency of app QoE degradation incidents compared to peer apps.

Security factor 624D may correspond to anomalous behavior from the computing item. For example, security factor 624D may be a score represented by number of malicious or anomalous connections from these devices blocked by a security service (e.g., as observed by and/or provided by server 406).

Turning back to FIG. 1, at step 106 one or more of the systems described herein may generate a weighting scheme for the computing item. For example, machine learning model 244 may generate weight factors 226.

The systems described herein may perform step 106 in a variety of ways. In one example, as illustrated in FIG. 5, ML model 544B may correspond to a ML model trained to predict weight factors for the computing item, using for instance, performance factors 524, telemetry data 522, and/or other available data. In some implementations, ML model 544B may be trained to classify performance factors 524 and/or telemetry data 522 to identify the computing item as a particular device model, app, product type, etc.

Using the type, ML model 544B may determine appropriate values for weight factors 526, which in some implementations correspond to weights (e.g., scaling factors, percentages, ratios, ranking, etc.) such that different performance factors 524 may be given different weight factors 526. For example, for certain device types, such as security cameras, connectivity reliability and security may be a more important factor than longevity or popularity. Other computing items, such as a game app, may value popularity and longevity. ML model 544B may therefore determine weight factors 526 for predicting and balancing performance factors 524.

FIG. 6 illustrates that each performance factor (e.g., popularity factor 624A, longevity factor 624B, connectivity reliability factor 624C, and security factor 624D) having a corresponding weight factor (e.g., a weight factor 626A, a weight factor 626B, a weight factor 626C, and a weight factor 626D, each corresponding to instances of weight factors 226). In other implementations, other weighting schemes may be used.

Returning now to FIG. 1, at step 108 one or more of the systems described herein may determine a performance metric for the computing item by applying the weighting scheme to the plurality of performance factors. For example, system 200 (e.g., processor 230 and/or more specifically machine learning model 244) may apply weight factors 226 to performance factors 224 to calculate performance metric 228.

In some embodiments, a performance metric as referred to herein may correspond to a comprehensive (e.g., using available telemetry data), multi-faceted (e.g., by factoring multiple performance attributes) experience score (e.g., quantifying a user experience) (or value/metric) representing an unbiased overview based on monitoring usage of a computing item over its lifetime. The performance metric may be a scaled value (e.g., from 0 to 100, or other appropriate scale), an absolute value, a ranking, or represented in any other appropriate value.

The systems described herein may perform step 108 in a variety of ways. In one example, as illustrated in FIG. 5, ML model 544C may apply weight factors 526 to performance factors 524, as further illustrated in FIG. 6. For example, each of the performance factors (e.g., popularity factor 624A, longevity factor 624B, connectivity reliability factor 624C, and security factor 624D) may be mathematically combined with their corresponding weight factor (e.g., weight factor 626A, weight factor 626B, weight factor 626C, and weight factor 626D), such as by multiplying, and the resulting values further mathematically combined (e.g., accumulated or added together) into a performance metric 628 (corresponding to performance metric 228). In other weighting schemes, other linear/mathematical combinations may be applied.

In yet other examples, ML model 544C may use performance factors 524 and weight factors 526 as inputs to classify or otherwise predict performance metric 528, such that performance metric 528 may not necessarily be a linear combination of values. In yet further examples, one or more of the steps described herein may be substeps of an overall process, such as ML models 544A-544C corresponding to a combined/single model using telemetry data 522 as an input, and outputting performance metric 528.

In some implementations, ML model 544D may generate an analysis 529 from performance metric 528. For example, performance metric 528 may be periodically recalculated based on updated telemetry data 522 (e.g., every week, month, etc.), which may further be performed offline. Based on the updated values, ML model 544D may predict analysis 529 including a trend for the computing item and/or a future prediction for performance metric 528.

In other examples, ML model 544D may correspond to a generative language model that produces analysis 529 including an assessment (e.g., as a written description) of the computing item based on the performance metric 528, which may include descriptions of positive and/or negative features of the computing item. In yet other example, ML model 544D may provide an assessment of multiple computing items. For example, ML model 544D may identify the computing items of a user, identify corresponding performance metric 528 for each computing item, and provide analysis 529 that may include individual and/or collective assessment of the computing items for the user.

Moreover, one or more of the steps described herein may be substeps of an overall process, such as ML models 544A-544D corresponding to a combined/single model using telemetry data 522 as an input, and outputting analysis 529.

Turning back to FIG. 2, in some examples, system 200 may present performance metric 228 (and/or analysis 529), for example in a separate user interface and/or as part of another software user interface. Users may be able to find and compare performance metrics for various computing items (e.g., based on model, category, location, etc.), perform analysis, monitor changes, identify problematic devices/apps, etc.

In some aspects, the techniques described herein relate to a computer-implemented method including: receiving telemetry data from a plurality of devices corresponding to a computing item; predicting a plurality of performance factors for the computing item from the received telemetry data; generating a weighting scheme for the computing item; and determining a performance metric for the computing item by applying the weighting scheme to the plurality of performance factors.

In some aspects, the techniques described herein relate to a computer-implemented method, wherein predicting the plurality of performance factors further includes using a machine learning model trained to predict performance factors for the computing item.

In some aspects, the techniques described herein relate to a computer-implemented method, wherein predicting the plurality of performance factors further includes: detecting a sparsity of the received telemetry data; using a machine learning model to augment the telemetry data; predicting the plurality of performance factors using the augmented telemetry data; and causing the computing item to execute based on the performance metric.

In some aspects, the techniques described herein relate to a computer-implemented method, wherein predicting the plurality of performance factors further includes using a machine learning model to remove outlier data from the received telemetry data.

In some aspects, the techniques described herein relate to a computer-implemented method, wherein the outlier data corresponds to at least one of temporary device usage, guest device usage, or poor network usage.

In some aspects, the techniques described herein relate to a computer-implemented method, wherein generating the weighting scheme further includes using a machine learning model trained to predict weight factors for the computing item.

In some aspects, the techniques described herein relate to a computer-implemented method, further including periodically recalculating the performance metric based on updated telemetry data.

In some aspects, the techniques described herein relate to a computer-implemented method, further including predicting a trend for the computing item based on the performance metric.

In some aspects, the techniques described herein relate to a computer-implemented method, wherein the telemetry data includes at least one of device usage data, network connectivity data, or device security data.

In some aspects, the techniques described herein relate to a computer-implemented method, wherein the plurality of performance factors includes at least one of: a popularity factor corresponding to per capita counts of the computing item; a longevity factor corresponding to a usage churn rate of the computing item; a connectivity reliability factor corresponding to network-related degradation events relating to the computing item; or a security factor corresponding to anomalous behavior from the computing item.

In some aspects, the techniques described herein relate to a computer-implemented method, further including providing, using a generative language model, an assessment of the computing item based on the performance metric.

In some aspects, the techniques described herein relate to a computer-implemented method, wherein the computing item corresponds to at least one of a computer hardware item or a computer software item.

In some aspects, the techniques described herein relate to a system including: at least one physical processor; and physical memory including computer-executable instructions that, when executed by the physical processor, cause the physical processor to: receive telemetry data from a plurality of devices corresponding to a computing item; predict a plurality of performance factors for the computing item from the received telemetry data; generate a weighting scheme for the computing item; and determine a performance metric for the computing item by applying the weighting scheme to the plurality of performance factors.

In some aspects, the techniques described herein relate to a system, wherein the instructions further cause the physical processor to use one or more machine learning models to perform at least one of: removing outlier data from the received telemetry data; detecting a sparsity of the received telemetry data; augmenting the telemetry data; predicting the plurality of performance factors using the augmented telemetry data; or predicting weight factors for the computing item.

In some aspects, the techniques described herein relate to a system, wherein the instructions further cause the physical processor to: periodically recalculate the performance metric based on updated telemetry data; and predict a trend for the computing item based on the performance metric.

In some aspects, the techniques described herein relate to a system, wherein the plurality of performance factors includes at least one of: a popularity factor corresponding to per capita counts of the computing item; a longevity factor corresponding to a usage churn rate of the computing item; a connectivity reliability factor corresponding to network-related degradation events relating to the computing item; or a security factor corresponding to anomalous behavior from the computing item.

In some aspects, the techniques described herein relate to a system, further including instructions that cause the physical processor to provide, using a generative language model, an assessment of the computing item based on the performance metric.

In some aspects, the techniques described herein relate to a system, wherein the computing item corresponds to at least one of a computer hardware item or a computer software item.

In some aspects, the techniques described herein relate to a non-transitory computer-readable medium including one or more computer-executable instructions that, when executed by at least one processor of a computing device, cause the computing device to: receive telemetry data from a plurality of devices corresponding to a computing item; predict a plurality of performance factors for the computing item from the received telemetry data; generate a weighting scheme for the computing item; and determine a performance metric for the computing item by applying the weighting scheme to the plurality of performance factors.

In some aspects, the techniques described herein relate to a non-transitory computer-readable medium, wherein the instructions further cause the computing device to use one or more machine learning models to perform at least one of: removing outlier data from the received telemetry data; detecting a sparsity of the received telemetry data; augmenting the telemetry data; predicting the plurality of performance factors using the augmented telemetry data; predicting weight factors for the computing item; predict a trend for the computing item based on the performance metric; or provide an assessment of the computing item based on the performance metric.

As detailed above, the computing devices and systems described and/or illustrated herein broadly represent any type or form of computing device or system capable of executing computer-readable instructions, such as those contained within the memory devices described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), hardware accelerators, graphics processing units (GPUs), co-processors, portions of one or more of the same, variations or combinations of one or more of the same, or any other suitable physical processor.

Although described/illustrated as separate elements, the instructions described and/or illustrated herein may represent portions of a single instruction, code, program, and/or application. In addition, in certain embodiments one or more of these instructions may represent one or more software applications or programs that, when executed by a computing device, may cause the computing device to perform one or more tasks. For example, one or more of the instructions described and/or illustrated herein may represent instructions stored and configured to run on one or more of the computing devices or systems described and/or illustrated herein. One or more of these instructions may also represent all or portions of one or more special-purpose computers configured to perform one or more tasks.

In addition, one or more of the modules described herein may transform data, physical devices, and/or representations of physical devices from one form to another. For example, one or more of the instructions recited herein may receive telemetry data to be transformed, transform the data, output a result of the transformation to predict performance factors, use the result of the transformation to predict a performance metric, and store the result of the transformation to maintain performance metrics. Additionally or alternatively, one or more of the instructions recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving telemetry data from a plurality of devices corresponding to a computing item;
predicting a plurality of performance factors for the computing item from the received telemetry data;
generating a weighting scheme for the computing item;
determining a performance metric for the computing item by applying the weighting scheme to the plurality of performance factors; and
causing the computing item to execute based on the performance metric.

2. The computer-implemented method of claim 1, wherein predicting the plurality of performance factors further comprises using a machine learning model trained to predict performance factors for the computing item.

3. The computer-implemented method of claim 1, wherein predicting the plurality of performance factors further comprises:
detecting a sparsity of the received telemetry data;
using a machine learning model to augment the telemetry data; and
predicting the plurality of performance factors using the augmented telemetry data.

4. The computer-implemented method of claim 1, wherein predicting the plurality of performance factors further comprises using a machine learning model to remove outlier data from the received telemetry data.

5. The computer-implemented method of claim 4, wherein the outlier data corresponds to at least one of temporary device usage, guest device usage, or poor network usage.

6. The computer-implemented method of claim 1, wherein generating the weighting scheme further comprises using a machine learning model trained to predict weight factors for the computing item.

7. The computer-implemented method of claim 1, further comprising periodically recalculating the performance metric based on updated telemetry data.

8. The computer-implemented method of claim 7, further comprising predicting a trend for the computing item based on the performance metric.

9. The computer-implemented method of claim 1, wherein the telemetry data includes at least one of device usage data, network connectivity data, or device security data.

10. The computer-implemented method of claim 1, wherein the plurality of performance factors includes at least one of:
a popularity factor corresponding to per capita counts of the computing item;
a longevity factor corresponding to a usage churn rate of the computing item;
a connectivity reliability factor corresponding to network-related degradation events relating to the computing item; and
a security factor corresponding to anomalous behavior from the computing item.

11. The computer-implemented method of claim 1, further comprising providing, using a generative language model, an assessment of the computing item based on the performance metric.

12. The computer-implemented method of claim 1, wherein the computing item corresponds to at least one of a computer hardware item or a computer software item.

13. A system comprising:
at least one physical processor; and
physical memory comprising computer-executable instructions that, when executed by the physical processor, cause the physical processor to:
receive telemetry data from a plurality of devices corresponding to a computing item;
predict a plurality of performance factors for the computing item from the received telemetry data;
generate a weighting scheme for the computing item;
determine a performance metric for the computing item by applying the weighting scheme to the plurality of performance factors; and
cause the computing item to execute based on the performance metric.

14. The system of claim 13, wherein the instructions further cause the physical processor to use one or more machine learning models to perform at least one of:
removing outlier data from the received telemetry data;
detecting a sparsity of the received telemetry data;
augmenting the telemetry data;
predicting the plurality of performance factors using the augmented telemetry data; and
predicting weight factors for the computing item.

15. The system of claim 13, wherein the instructions further cause the physical processor to:
periodically recalculate the performance metric based on updated telemetry data; and
predict a trend for the computing item based on the performance metric.

16. The system of claim 13, wherein the plurality of performance factors includes at least one of:
a popularity factor corresponding to per capita counts of the computing item;
a longevity factor corresponding to a usage churn rate of the computing item;
a connectivity reliability factor corresponding to network-related degradation events relating to the computing item; and
a security factor corresponding to anomalous behavior from the computing item.

17. The system of claim 13, further comprising instructions that cause the physical processor to provide, using a generative language model, an assessment of the computing item based on the performance metric.

18. The system of claim 13, wherein the computing item corresponds to at least one of a computer hardware item or a computer software item.

19. A non-transitory computer-readable medium comprising one or more computer-executable instructions that, when executed by at least one processor of a computing device, cause the computing device to:
receive telemetry data from a plurality of devices corresponding to a computing item;
predict a plurality of performance factors for the computing item from the received telemetry data;
generate a weighting scheme for the computing item;
determine a performance metric for the computing item by applying the weighting scheme to the plurality of performance factors; and
cause the computing item to execute based on the performance metric.

20. The non-transitory computer-readable medium of claim 19, wherein the instructions further cause the computing device to use one or more machine learning models to perform at least one of:
removing outlier data from the received telemetry data;
detecting a sparsity of the received telemetry data;
augmenting the telemetry data;
predicting the plurality of performance factors using the augmented telemetry data;
predicting weight factors for the computing item;
predict a trend for the computing item based on the performance metric; and
provide an assessment of the computing item based on the performance metric.
